(19) United States
(12) Patent Application Publication
(10) Pub. No.: US 2010/0061023 A1
(43) Pub. Date: Mar. 11, 2010

(54) MAGNETIC HEAD DEVICE AND MAGNETIC DISK DRIVE APPARATUS WITH THE MAGNETIC HEAD DEVICE

(75) Inventors: Naoki OHTA, Tokyo (JP); Kei HIRATA, Tokyo (JP)

Correspondence Address: Frommer Lawrence & Haug LLP, 745 Fifth Avenue, New York, NY, 10151, US

(73) Assignee: TDK Corporation, Tokyo (JP)

(21) Appl. No.: 12/208,828

(22) Filed: Sep. 11, 2008

(51) Int. Cl. G11B 5/127

(52) U.S. Cl. 360/324.12; G9B/5.04

(57) ABSTRACT

A magnetic head device includes a magnetic head section having a first free layer with a magnetization orientation that is not previously defined but changes depending upon only external magnetic field applied, a second free layer with a magnetization orientation that is not previously defined but changes depending upon only external magnetic field applied, a nonmagnetic intermediate layer sandwiched between the first free layer and the second free layer, a first electrode layer stacked on a surface of the first free layer opposite to the nonmagnetic intermediate layer, and a second electrode layer stacked on a surface of the second free layer opposite to the nonmagnetic intermediate layer; a sense-current supply means for flowing a sense current across the first electrode layer and the second electrode layer of the magnetic head section; and a frequency divider circuit for dividing by two a frequency of an output signal produced across the first electrode layer and the second electrode layer of the magnetic head section.

### BACKGROUND OF THE INVENTION

1. Field of the Invention

The present invention relates to a magnetic head device with a magnetoresistive effect (MR) read head element, and to a magnetic disk drive apparatus with the magnetic head device.

2. Description of the Related Art

Recently, in order to satisfy the demand for larger recording capacity and downsizing in a magnetic disk drive apparatus, higher sensitivity and resolution of a magnetic head are required. Thus, as for a thin-film magnetic head with a recording density performance of 100 Gbspi or more, a tunnel magnetoresistive effect (TMR) head with a TMR read head element having a current perpendicular to plane (CPP) structure capable of achieving higher sensitivity and resolution is coming into practical use instead of a general giant magnetoresistive effect (GMR) head with a GMR read head element having a current in plane (CIP) structure.

The head structure in which a sense current flows in a direction parallel with surfaces of laminated layers is called as the CIP structure, whereas the other head structure in which the sense current flows in a direction perpendicular to surfaces of laminated layers is called as the CPP structure. In recent years, GMR heads with the CPP structure are being developed.

Even in such MR read head element with the CPP structure capable of narrowing the read gap, when it is required to further narrow the read gap in order to scale up high resolution in the bit orientation, it is necessary to narrow a total thickness of a MR multi-layered structure. Typical MR multi-layered structure in a bottom-shield type TMR read head element or a bottom-shield type CPP-GMR read head element has a buffer layer/a pinning layer/a pinned layer/a tunnel barrier layer or a spacer layer/a free layer/a cap layer laminated in this order from the substrate side.

In order to make thinner the total thickness of the MR multi-layered structure, it is necessary to decrease a thickness of the pinned layer and/or the pinning layer.

The pinned layer often adopts a synthetic structure, because it is necessary to fix its magnetization orientation immunity to an external magnetic field applied. The pinned layer with the synthetic structure has in general a stack of an outer-pinned layer, a nonmagnetic intermediate layer and an inner-pinned layer. In order to fix the magnetization orientation of the outer-pinned layer, a pinning layer made of an anti-ferromagnetic material is formed to contact to the outer-pinned layer. As for the anti-ferromagnetic material of the pinning layer, iridium manganese (IrMn) is typically used.

The magnetization orientation of the outer-pinned layer is fixed by exchange-coupling between the outer-pinned layer and the pinning layer of the synthetic pinned layer. The magnetization orientation of the inner-pinned layer is fixed by the anti-ferromagnetic coupling between the inner-pinned layer and the outer-pinned layer through the nonmagnetic intermediate layer. Since the magnetization orientations of the inner-pinned layer and the outer-pinned layer are inversely parallel to each other, the total magnetization of the synthetic pinned layer is stably controlled. Although the synthetic pinned layer has such merit, due to the multi-layered structure, it is difficult to decrease its thickness. Also, when IrMn is used as for the pinning layer, because sufficient thickness thereof is required, it is quite difficult to make thinner the total thickness of the MR multi-layered structure.

U.S. Pat. No. 7,035,062 discloses a CPP structure MR element with a new layer structure that is quite different from the above-mentioned conventional layer structure of the MR multi-layers. This new layer structure has two free layers with magnetization orientations that are changed depending upon an external magnetic field applied thereto, a spacer layer sandwiched between these free layers, and a bias magnetic layer formed on a back side face of the multi-layered MR structure opposite to a recording medium side face, for applying a bias magnetic field to the two free layers. According to this MR element, the two free layers receive the bias magnetic field in a direction perpendicular to the recording medium opposed surface, so that magnetization orientations of these two free layers are perpendicular to each other when no external magnetic field is applied and that magnetization orientations of these two free layers are parallel or inversely parallel to each other when an external magnetic field is applied. Since neither pinned layer nor pinning layer is required, this MR element can make thinner the total thickness.

However, the layer structure of the MR element disclosed in U.S. Pat. No. 7,035,062 has the following problems: (1) since it is necessary to keep a certain space (a certain thickness of shield gap layers) between the MR multi-layered structure and shield layers arranged under and above the MR multi-layered structure in order to avoid magnetic coupling of the two free layers with the shield layers, the total thickness of the MR element cannot be so reduced, and (2) since it is necessary that magnetization orientations of the two free layers are perpendicular to each other when no external magnetic field is applied and that magnetization orientations of the two free layers are parallel or inversely parallel to each other when an external magnetic field is applied, these two free layers have to fabricate with an very high accuracy causing the manufacturing of the MR element to make extremely difficult.

### SUMMARY OF THE INVENTION

It is therefore an object of the present invention to provide a magnetic head device with an MR read head element and a magnetic disk drive apparatus with the magnetic head device, whereby manufacturing of the magnetic head device is extremely easy and a thickness of the MR read head element can be greatly reduced.

According to the present invention, a magnetic head device includes a magnetic head section having a first free layer with a magnetization orientation that is not previously defined but changes depending upon only external magnetic field applied, a second free layer with a magnetization orientation that is not previously defined but changes depending upon only external magnetic field applied, a nonmagnetic intermediate layer sandwiched between the first free layer and the second free layer, a first electrode layer stacked on a surface of the first free layer opposite to the nonmagnetic intermediate layer, and a second electrode layer stacked on a surface of the second free layer opposite to the nonmagnetic intermediate layer; a sense-current supply means for flowing a sense current across the first electrode layer and the second electrode layer of the magnetic head section; and a frequency divider circuit for dividing by two a frequency of an output signal produced across the first electrode layer and the second electrode layer of the magnetic head section.

No magnetic bias layer for applying a bias to the free layers is formed and thus magnetization orientations of the first free layer and the second free layer are not previously defined but change depending upon only external magnetic field applied thereto. The nonmagnetic intermediate layer is formed between the first free layer and the second free layer. By flowing a sense current through the free layers in a direction perpendicular to surfaces of laminated layers and by obtaining an output across the first free layer and the second free layer, not magnetic fields from bits of the recorded medium themselves but only difference between magnetic field directions of the neighboring bits of the recorded medium can be detected. In other words, only when the direction of the recorded magnetic field changes between the neighboring bits, a pulse-shaped output is produced. Therefore, according to the present invention, the conventional concept that bit length is determined depending upon a read gap length is inapplicable but the bit length can be extremely reduced. However, since each free layer is very susceptible to the neighboring bits of the recorded medium when the bit length decreases less than the thickness of the free layer, the minimum bit length will be limited to the thickness of the free layer. As a result, according to the present invention, it is possible to extremely reduce the total thickness of the MR element. Also, according to the present invention, since it is not necessary to accurately control the magnetization orientations of two free layers, manufacturing of the MR element is very easy.

Furthermore, according to the present invention, it is not necessary to form shield layers because (1) only difference between magnetic field directions of the neighboring bits is detected, (2) in principle, effect of the neighboring bit is quite small, and (3) there is no need for defining a read gap length. Therefore, layer structure can be further simplified.

It is preferred that the magnetic head section further includes a buffer layer between the first free layer and the first electrode layer.

It is also preferred that the magnetic head section further includes a cap layer between the second free layer and the second electrode layer.

It is further preferred that the first electrode layer and the second electrode layer of the magnetic head section serve as a first shield layer and a second shield layer, respectively.

It is still further preferred that the nonmagnetic intermediate layer of the magnetic head section is a tunnel barrier layer or a nonmagnetic conductive layer.

It is further preferred that the nonmagnetic intermediate layer of the magnetic head section has a thickness of 0.6 nm or more or 4.0 nm or less. More preferably, the nonmagnetic intermediate layer of the magnetic head section has a thickness of 2.5 nm or less.

It is further preferred that the frequency divider circuit includes a flip-flop circuit.

According to the present invention, also, a magnetic disk drive apparatus has a magnetic disk, a magnetic head device with a magnetic head section, and a support means for supporting the magnetic head section so that the magnetic head section opposes to a surface of the magnetic disk. The magnetic head device includes the magnetic head section including a first free layer with a magnetization orientation that is not previously defined but changes depending upon only external magnetic field applied, a second free layer with a magnetization orientation that is not previously defined but changes depending upon only external magnetic field applied, a nonmagnetic intermediate layer sandwiched between the first free layer and the second free layer, a first electrode layer stacked on a surface of the first free layer opposite to the nonmagnetic intermediate layer, and a second electrode layer stacked on a surface of the second free layer opposite to the nonmagnetic intermediate layer; a sense-current supply means for flowing a sense current across the first electrode layer and the second electrode layer of the magnetic head section; and a frequency divider circuit for dividing by two a frequency of an output signal produced across the first electrode layer and the second electrode layer of the magnetic head section.

Further objects and advantages of the present invention will be apparent from the following description of preferred embodiments of the invention as illustrated in the accompanying drawings.

### BRIEF DESCRIPTION OF THE DRAWINGS

FIG. 1 is a perspective view schematically illustrating a main structure of a magnetic disk drive apparatus as an embodiment according to the present invention;

FIG. 2 is a perspective view illustrating an example of the structure of a head gimbal assembly (HGA) shown in FIG. 1;

FIG. 3 is a perspective view illustrating a thin-film magnetic head mounted at the end of the HGA of FIG. 2;

FIG. 4 is a central cross sectional view schematically illustrating the structure of the thin-film magnetic head shown in FIG. 3;

FIG. 5 is a perspective view schematically illustrating a configuration of an MR read head element of the thin-film magnetic head shown in FIGS. 3 and 4;

FIG. 6 is a graph illustrating relationships between thickness and MR ratio of a tunnel barrier layer of magnesium oxide (MgO) and a nonmagnetic conductive layer of copper (Cu) as a nonmagnetic intermediate layer;

FIG. 7 is a block diagram illustrating a circuit configuration of a read/write control circuit in the magnetic disk drive apparatus shown in FIG. 1;

FIG. 8 is a view illustrating principle of operations of the MR read head element according to the present invention;

FIG. 9 is a view illustrating, by comparison, operations of the MR read head element disclosed in U.S. Pat. No. 7,035,062 and of the MR read head element according to the present invention; and

FIG. 10 is a perspective view schematically illustrating a configuration of an MR read head element of a thin-film magnetic head in another embodiment according to the present invention.

### DESCRIPTION OF THE PREFERRED EMBODIMENTS

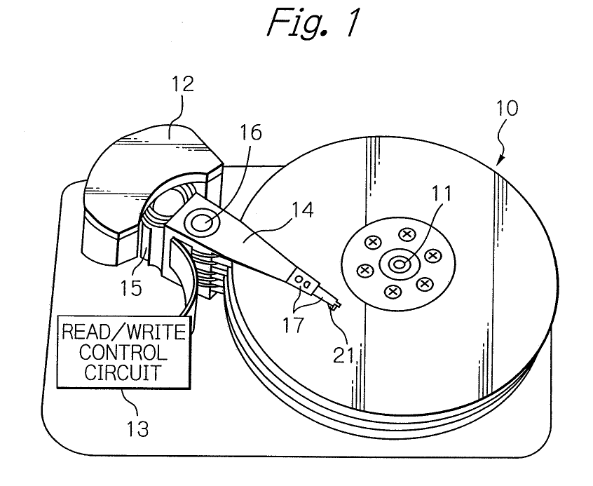

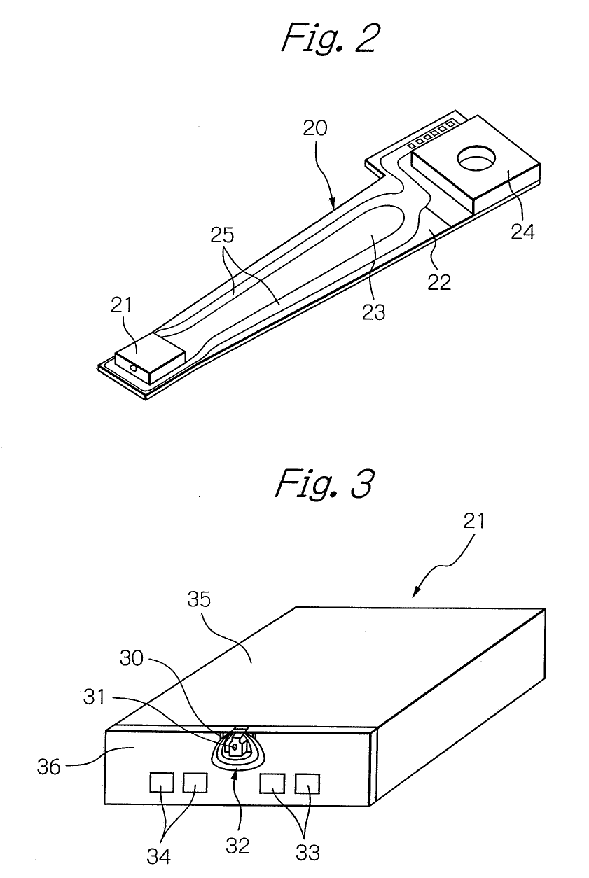

FIG. 1 schematically illustrates the main structure of a magnetic disk drive apparatus in an embodiment of the present invention, FIG. 2 illustrates an example of the structure of an HGA of FIG. 1, and FIG. 3 illustrates the composite thin-film magnetic head mounted at the end of the HGA of FIG. 2.

In FIG. 1, a reference numeral 10 denotes a plurality of magnetic disks that rotate about a rotary axis of a spindle motor 11, 12 denotes an assembly carriage device for positioning the thin-film magnetic heads or magnetic head sliders on the track, and 13 denotes a read/write control circuit for controlling the read/write operation of the thin-film magnetic heads, respectively.

The assembly carriage device 12 includes a plurality of drive arms 14. The drive arms 14 are swingable about a pivot-bearing axis 16 by a voice coil motor (VCM) 15, and are stacked in a direction along this axis 16. Each of the drive arms 14 has an HGA 17 mounted at the end thereof. The HGA 17 includes a magnetic head slider 21 facing the surface of each magnetic disk 10. In modifications, the magnetic disk drive apparatus may include only a single magnetic disk 10, drive arm 14 and HGA 17.

As shown in FIG. 2, in each HGA, the magnetic head slider 21 is fixed onto the end of a suspension 20. The magnetic head slider 21 has an MR read head element with a CPP structure and an inductive write head element. Further, in the HGA, a terminal electrode of the magnetic head slider 21 is electrically connected to an end of a wiring member 25.

The suspension 20 includes mainly a load beam 22, a flexure 23, a base plate 24 and the wiring member 25. The load beam 22 generates a load to be applied to the magnetic head slider 21. The flexure 23 having elasticity is fixed onto and supported by the load beam 22. The base plate 24 is arranged on the base of the load beam 22. The wiring member 25 is arranged on the flexure 23 and the load beam 22, and includes lead conductors and connection pads electrically connected to both ends of the lead conductors.

It is obvious that the structure of the suspension according to the present invention is not limited to the above. Furthermore, although it is not shown, a head drive IC chip may be mounted on a middle of the suspension 20.

As shown in FIG. 3, the magnetic head slider 21 of this embodiment includes a composite thin-film magnetic head 32 and four signal terminal electrodes 33 and 34, on an element formed surface 36 that is one side surface when an air bearing surface (ABS) 35 of the magnetic head slider serves as the bottom surface. The thin-film magnetic head 32 includes an MR read head element with a CPP structure 30 and an inductive write head element 31 that are mutually stacked. The four signal terminal electrodes 33 and 34 are electrically connected to the MR read head element 30 and the inductive write head element 31, respectively. The positions of these terminal electrodes are not limited to those shown in FIG. 3.

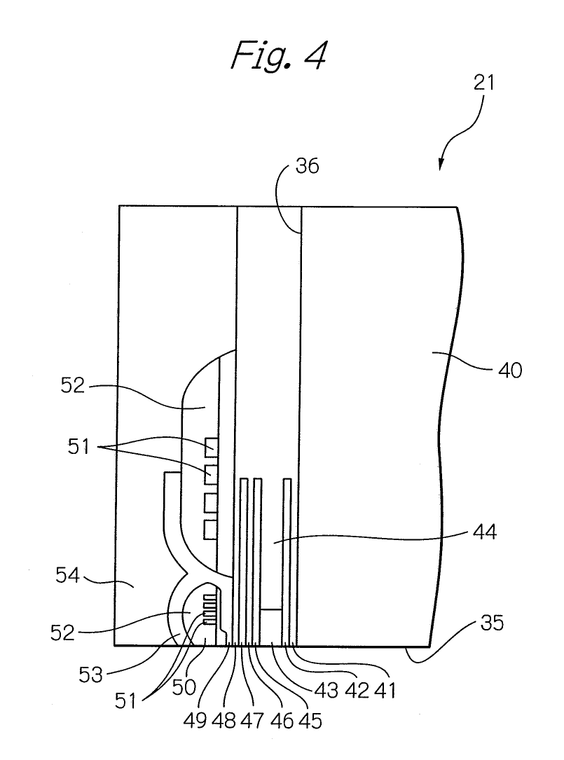

FIG. 4 schematically illustrates the structure of the thin-film magnetic head in this embodiment.

A slider substrate 40 is made of a conductive material such as AlTiC (Al₂O₃—TiC). The ABS 35 facing the surface of the magnetic disk is formed on the slider substrate 40. In operation, the magnetic head slider 21 hydrodynamically flies above the rotating magnetic disk with a predetermined flying height. An under insulation layer 41 is stacked on the element forming surface 36 of the slider substrate 40. A lower electrode layer 42 is stacked on the under insulation layer 41. This layer 42 can serve also as a lower magnetic shield layer. The under insulation layer 41 is made of an insulation material such as alumina (Al₂O₃) or silicon oxide (SiO₂) and has a thickness of about 0.05-10 μm. The lower electrode layer 42 is made of a magnetic metal material such as for example iron aluminum silicon (FeAlSi), nickel iron (NiFe), cobalt iron (CoFe), nickel iron cobalt (NiFeCo), iron nitride (FeN), iron zirconium nitride (FeZrN), iron tantalum nitride (FeTaN), cobalt zirconium niobium (CoZrNb), or cobalt zirconium tantalum (CoZrTa).

A CPP MR multi-layered structure 43 and an insulation layer 44 made of an insulation material such as Al₂O₃ or SiO₂ are formed on the lower electrode layer 42.

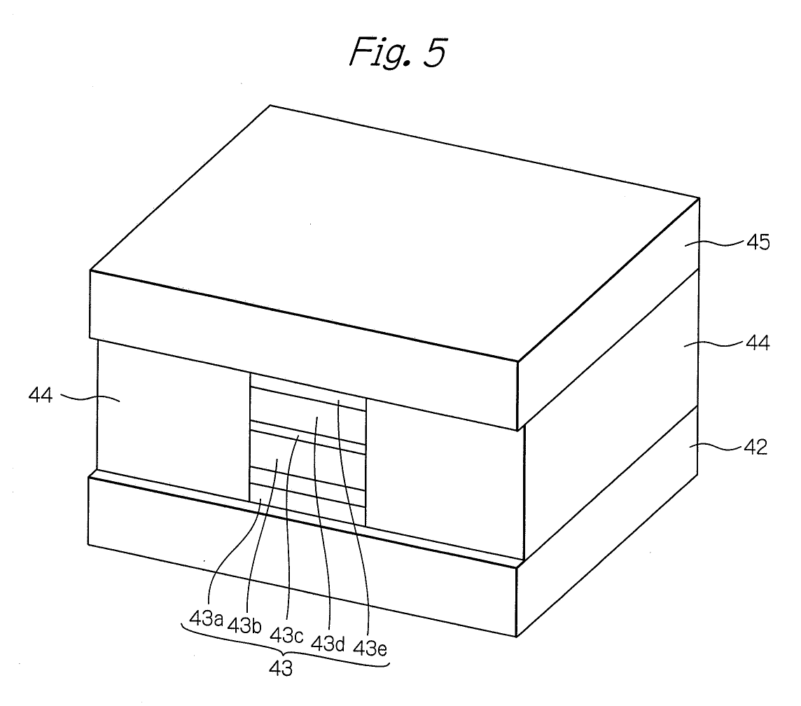

The CPP MR multi-layered structure 43 has, in case of a TMR element, a multi-layers of a buffer layer 43a, a first free layer 43b, a nonmagnetic intermediate layer of a tunnel barrier layer 43c, a second free layer 43d and a cap layer 43e as shown in FIG. 5. In case that the CPP MR multi-layered structure 43 is a CPP-GMR element, a nonmagnetic conductive layer is used instead of the tunnel barrier layer. It is apparent that various layer configurations other than the above-mentioned layer structure may be adopted for the CPP MR multi-layered structure 43.

On the CPP MR multi-layered structure 43 and the insulation layer 44, an upper electrode layer 45 is stacked. The upper electrode layer 45 also serves as an upper shield layer and feeds current to the MR multi-layered structure 43. This upper electrode layer 45 is made of a magnetic metal material such as for example FeAlSi, NiFe, CoFe, FeNiCo, FeN, FeZrN, FeTaN, CoZrNb or CoZrTa.

The MR read head element with CPP structure is configured by the lower electrode layer 42, the MR multi-layered structure 43, the insulation layer 44, the upper electrode layer 45 and lead conductive layers (not shown).

Above the upper electrode layer 45, an inter-elemental shield layer 47 for separating the MR read head element with CPP structure from the inductive write head element with perpendicular magnetic recording structure formed thereon and insulation layers 46 and 48 for sandwiching the inter-elemental shield layer 47 are stacked. The inter-elemental shield layer 47 is made of a metal material or a magnetic metal material such as for example FeAlSi, NiFe, CoFe, NiFeCo, FeN, FeZrN, FeTaN, CoZrNb or CoZrTa and has a thickness of preferably about 0.05-2 μm. The insulation layers 46 and 48 are made of an insulation material such as for example Al₂O₃ or SiO₂.

As shown in FIG. 4, on the inter-elemental shield layer 47 and the insulation layer 48, an inductive write head element including a main pole layer 49, an insulation gap layer 50, a write coil layer 51, a write coil insulation layer 52 and an auxiliary pole layer 53 is formed. The main pole layer 49 is made of a magnetic metal material such as for example FeAlSi, NiFe, CoFe, NiFeCo, FeN, FeZrN, FeTaN, CoZrNb or CoZrTa. The insulation gap layer 50 is made of a metal material such as for example ruthenium (Ru) or an insulation material such as for example SiO₂. The write coil layer 51 made of a conductive material such as for example Cu. The write coil insulation layer 52 is made of an insulation material such as a thermally cured resist. The auxiliary pole layer 53 is made of a magnetic metal material such as for example FeAlSi, NiFe, CoFe, NiFeCo, FeN, FeZrN, FeTaN, CoZrNb or CoZrTa. On the inductive write head element, a protection layer 54 made of an insulation material such as for example Al₂O₃ is stacked.

As for the inductive write head element with a perpendicular magnetic recording structure, various structures other than that illustrated in FIG. 4 may be applied. Although the write coil layer 51 has a single-layered structure in the above-mentioned embodiment, two-layered structure or other structure may be adopted.

FIG. 5 schematically illustrates a configuration of an MR read head element of the thin-film magnetic head shown in FIGS. 3 and 4. It should be noted that, in FIG. 5, a TMR read head element is illustrated as for the MR read head element with CPP structure.

As shown in the figure, on the lower electrode layer 42, the TMR multi-layered structure 43 and the insulation layer 44 are stacked. The TMR multi-layered structure 43 has the buffer layer 43a with a single-layered structure or a multi-layered structure made of a nonmagnetic conductive material such as for example tantalum (Ta) or Ru, stacked on the lower electrode layer 42. In a desired embodiment, the buffer layer 43a may be formed from a Ta layer with a thickness of about 1.0 nm and an Ru layer with a thickness of about 2.0 nm deposited on the Ta layer.

On the buffer layer 43a, the first free layer 43b, the tunnel barrier layer 43c and the second free layer 43d are sequentially stacked.

Each of the first free layer 43b and the second free layer 43d is formed from a two-layered structure made of magnetic metal materials such as for example CoFe and cobalt iron boron (CoFeB), or NiFe and nickel iron boron (NiFeB), or from a single-layered structure of a magnetic metal material such as for example cobalt nickel iron (CoNiFe), cobalt nickel iron boron (CoNiFeB), cobalt manganese silicon (CoMnSi), cobalt manganese germanium (CoMnGe), cobalt manganese aluminum (CoMnAl) or cobalt iron silicon (CoFeSi). In case that CoFeB is used, the composition thereof is desirably (Co(1-x)Fex)(1-y)By, where x=80-90 at % and y=15-30 at %. Under the conditions of x<80 at %, since a magnetostriction of CoFeB increases, a magnetic noise may be increased under the influence of external heat, stress or else.

A thickness of the first free layer 43b and/or the second free layer 43d is selected within a range of about 1.0-5.0 nm. If the thickness is thicker than about 5.0 nm, signal resolution deteriorates because this thickness of the free layer becomes in excess of a bit length at a recording density of 1 Tbpsi. If the thickness is thinner than about 1.0 nm, it is impossible to obtain a high-level reproduction signal because an MR ratio reduces.

The first free layer 43b and the second free layer 43d may be made of the same material and formed from the same layer structure, or made of different materials and formed from different layer structures to each other.

In a desired embodiment, the first free layer 43b may be formed from a (90CoFe)80B film with a thickness of about 1.5 nm and a 90CoFe film with a thickness of about 1.0 nm stacked on the (90CoFe)80B film. Also, the second free layer 43d may be formed from a 90(CoFe) film with a thickness of about 0.5 nm and a (90CoFe)80B film with a thickness of about 2.5 nm stacked on the 90(CoFe) film.

The tunnel barrier layer 43c is made of an oxide of for example magnesium (Mg), aluminum (Al), titanium (Ti), Ta, zirconium (Zr), hafnium (Hf), silicon (Si) or zinc (Zn). In a desired embodiment, the tunnel barrier layer 43c may be made of MgO.

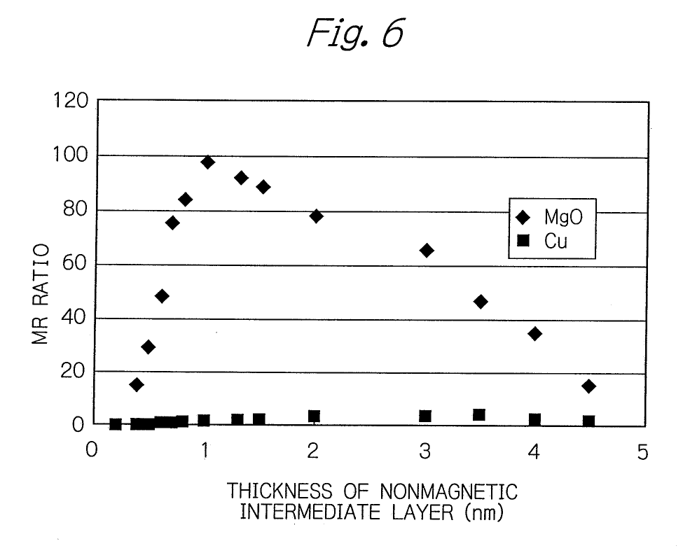

FIG. 6 illustrates relationships between a thickness and an MR ratio of a tunnel barrier layer of MgO and a nonmagnetic conductive layer of Cu as a nonmagnetic intermediate layer.

As will be noted from the figure, the thickness of the tunnel barrier layer 43c is selected within a range of about 0.6-4.0 nm, preferably a range of about 0.6-2.5 nm. If the thickness is thicker than about 4.0 nm, it is difficult to induce an MR ration because this thickness of the free layer becomes in excess of a spin-diffusion length of a nonmagnetic intermediate layer material such as for example MgO. If the thickness is thicker than about 2.5 nm, signal resolution may deteriorate because a thickness of the nonmagnetic intermediate layer becomes in excess of a size of a magnetization-transition region between bits. If the thickness is thinner than about 0.6 nm, it is difficult to realize a high resistance state since ferromagnetic coupling state between the first free layer 43b and the second free layer 43d due to interlayer coupling becomes very strong.

On the second free layer 43d, the cap layer 43e with a single-layered or two-layered structure made of a nonmagnetic conductive material such as for example Ru or Ta is stacked. In a desired embodiment, the cap layer 43e may be formed from an Ru layer with a thickness of about 1.0 nm and a Ta layer with a thickness of about 2.0 nm stacked on the Ru layer.

The aforementioned upper electrode layer 45 is stacked on the MR multi-layered structure 43 and the insulation layer 44.

It should be noted that, according to the present invention, no magnetic bias layer for applying a bias to the free layers is formed around the MR multi-layered structure 43. Therefore, magnetization orientations of the first free layer 43b and the second free layer 43d are not previously defined but will change depending upon only external magnetic field applied thereto.

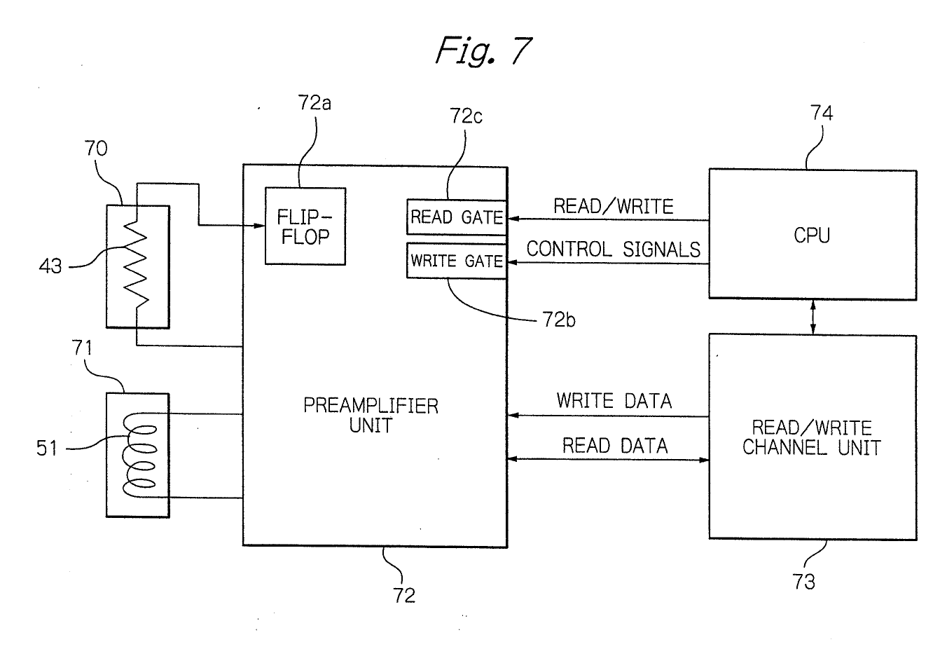

FIG. 7 illustrates a circuit configuration of the read/write control circuit 13 in the magnetic disk drive apparatus shown in FIG. 1.

In the figure, reference numeral 70 denotes the MR read head element with the MR multi-layered structure 43, 71 denotes the inductive write head element with the write coil layer 51, 72 denotes a preamplifier unit connected to the MR read head element 70 and the inductive write head element 71, 72a denotes a D-type flip-flop circuit as for a frequency divider circuit with a divide ratio of two formed in the preamplifier unit 72, 73 denotes a read/write channel unit, and 74 denotes a central processing unit (CPU), respectively. The divide-by-two frequency divider circuit according to the present invention may be configured from a T-type flip-flop circuit or various frequency dividers for inverting their output states in response to their pulse inputs instead of the D-type flip-flop circuit.

Write data supplied from the read/write channel unit 73 are provided to the preamplifier unit 72. The preamplifier unit 72 receives a write control signal from the CPU 74 at a write gate 72b and thus supplies a write current corresponding to the write data to the coil layer 51 of the inductive write head element 71 only when the write control signal instructs to executer write operations, so that recording on the magnetic disk is performed.

The preamplifier unit 72 also receives a read control signal from the CPU 74 at a read gate 72c and thus supplies a sense current to the MR multi-layered structure 43 of the MR read head element 70 only when the read control signal instructs to executer read operations. Output pulses from the MR read head element 70 are applied to the flip-flop circuit 72a to produce a read signal. The read signal is amplified and demodulated to produce read data, which are provided to the read/write channel unit 73.

It is apparent that circuit configuration of the read/write control circuit 13 is not limited to that shown in FIG. 7. Also, the read/write operations may be instructed in response to signals other than the read/write control signals.

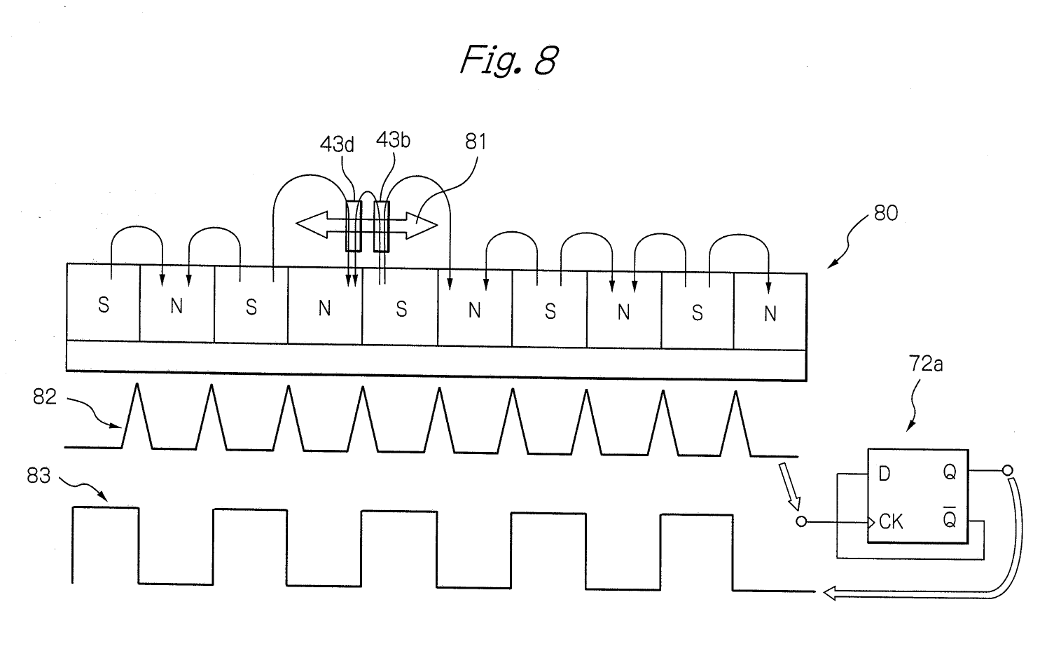

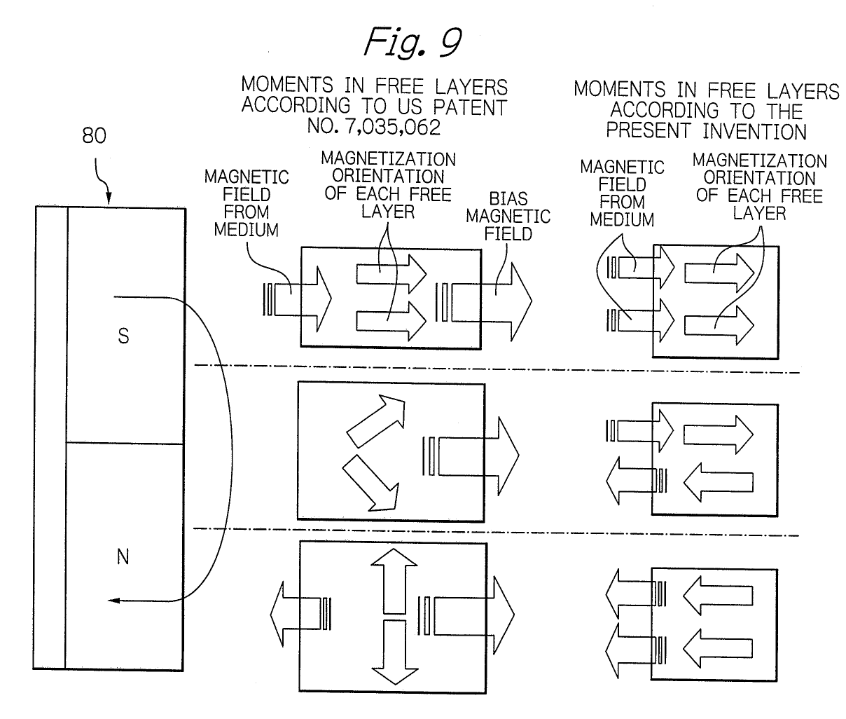

FIG. 8 illustrates principle of operations of the MR read head element according to the present invention, and FIG. 9 illustrates, by comparison, operations of the MR read head element disclosed in U.S. Pat. No. 7,035,062 and of the MR read head element according to the present invention. Hereinafter, operations, functions and advantages of the magnetic head device according to the present invention will be described.

As mentioned before, no magnetic bias layer for applying a bias to the free layer is formed around the MR multi-layered structure 43. Therefore, magnetization orientations of the first free layer 43b and the second free layer 43d are not previously defined but will change depending upon only external magnetic field applied thereto. The tunnel barrier layer 43c as for the nonmagnetic intermediate layer is formed between the first free layer 43b and the second free layer 43d, and a sense current flows in a direction perpendicular to surfaces of laminated layers. Thus, an output is obtained across the first free layer 43b and the second free layer 43d, therefore across the lower electrode layer 42 and the upper electrode layer 45.

As shown in FIG. 8, when an MR read head element relatively moves in directions 81 along a surface of a magnetic medium or magnetic disk 80 on which magnetic information are perpendicularly recorded, the first free layer 43b and the second free layer 43d of the MR read head element detect magnetic fields from neighboring bits (N-pole and S-pole), respectively. By flowing a sense current through the free layers in a direction perpendicular to surfaces of laminated layers and by obtaining an output across the first free layer 43b and the second free layer 43d, only difference between magnetic field directions of the neighboring bits or the N-pole and the S-pole can be detected. In other words, only when the direction of the recorded magnetic field changes from N to S or from S to N between the neighboring bits, a pulse-shaped output 82 shown in FIG. 8 is produced. Since this pulse-shaped output 82 is applied to a latch-input terminal of the flip-flop circuit 72a that is an example of the divide-by-two frequency divider circuit according to the present invention, a reproduced output 83 corresponding to the respective bits can be obtained from the flip-flop circuit 72a.

FIG. 9 illustrates how the magnetization orientation of each free layer changes in response to magnetic field applied from the S-pole and the N-pole of the magnetic medium or magnetic disk 80. As will be noted from this figure, according to the present invention, because the magnetization orientations in the first free layer and the second free layer are reversed to each other at the boarder at which the direction of the recorded magnetic field changes from N to S or from S to N, the pulse-shaped output 82 is produced.

Therefore, according to the present invention, the conventional concept that bit length is determined depending upon a read gap length is inapplicable but the bit length can be extremely reduced. However, since each free layer is very susceptible to the neighboring bits of the magnetic medium when the bit length decreases less than the thickness of the free layer, the minimum bit length will be limited to the thickness of the free layer. Thus, according to the present invention, it is possible to extremely reduce the total thickness of the MR element.

As shown in FIG. 9, according to the MR read head element disclosed in U.S. Pat. No. 7,035,062, it is necessary that magnetization orientations of two free layers are accurately perpendicular to each other when no external magnetic field is applied and are accurately anti-parallel or parallel to each other when an external magnetic field is applied. Thus, it is required to extremely precisely fabricate these two free layers. Contrary to this, according to the present invention, since it is not necessary to accurately control the magnetization orientations of two free layers, manufacturing of the MR element is very easy.

Furthermore, according to the present invention, it is not necessary to form shield layers because (1) only difference between magnetic field directions of the neighboring bits is detected, (2) in principle, effect of the neighboring bit is quite small, and (3) there is no need for defining a read gap length. Therefore, layer structure can be further simplified.

In the aforementioned embodiments, according to the present invention, a CPP-GMR read head element may be used as for the MR read head element instead of the TMR read head element.

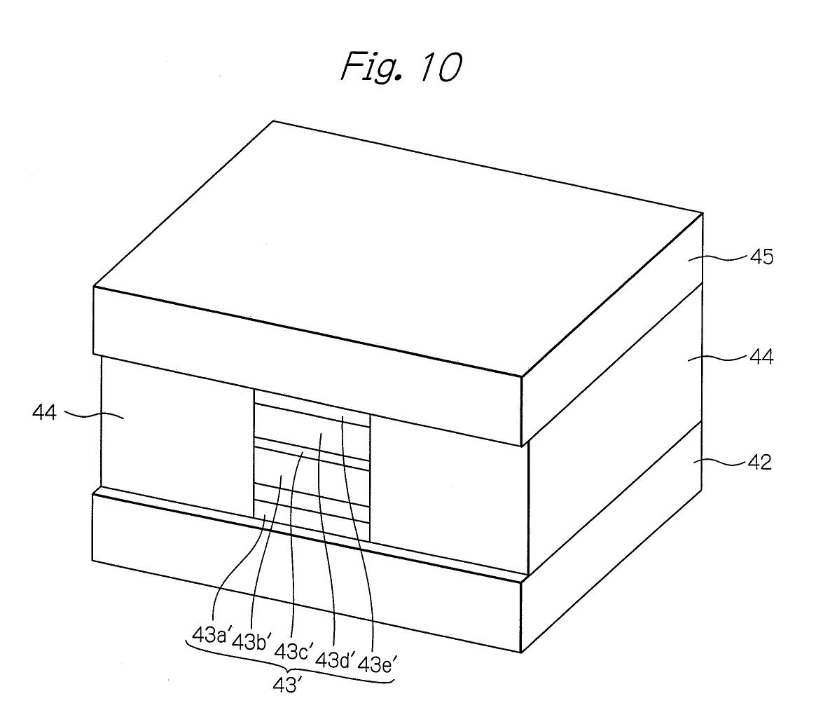

FIG. 10 is schematically illustrates a configuration of an MR read head element of the thin-film magnetic head in another embodiment according to the present invention. In this embodiment, the MR read head element is a CPP-GMR read head element. Therefore, a nonmagnetic conductive layer is used instead of the tunnel barrier layer and other configuration of the thin-film magnetic head device is the same as the embodiment mentioned with reference to FIGS. 1 to 9. In FIG. 10, the same reference numerals are used for the same elements as these shown in FIG. 5.

As shown in FIG. 10, on the lower electrode layer 42, a CPP-GMR multi-layered structure 43′ and the insulation layer 44 are stacked. The CPP-GMR multi-layered structure 43′ has a buffer layer 43a′ with a single-layered structure or a multi-layered structure made of a nonmagnetic conductive material such as for example Ta or Ru, stacked on the lower electrode layer 42. In a desired embodiment, the buffer layer 43a′ may be formed from a Ta layer with a thickness of about 1.0 nm and an Ru layer with a thickness of about 2.0 nm deposited on the Ta layer.

On the buffer layer 43a′, a first free layer 43b′, a nonmagnetic conductive layer 43c′ and a second free layer 43d′ are sequentially stacked.

Each of the first free layer 43b′ and the second free layer 43d′ is formed from a two-layered structure made of magnetic metal materials such as for example CoFe and CoFeB, or NiFe and NiFeB, or from a single-layered structure of a magnetic metal material such as for example CoNiFe, CoNiFeB, CoMnSi, CoMnGe, CoMnAl or CoFeSi. In case that CoFeB is used, the composition thereof is desirably (Co(1-x)Fex)(1-y)By, where x=80-90 at % and y=15-30 at %. Under the conditions of x<80 at %, since a magnetostriction of CoFeB increases, a magnetic noise may be increased under the influence of external heat, stress or else.

A thickness of the first free layer 43b′ and/or the second free layer 43d′ is selected within a range of about 1.0-5.0 nm. If the thickness is thicker than about 5.0 nm, signal resolution deteriorates because this thickness of the free layer becomes in excess of a bit length at a recording density of 1 Tbpsi. If the thickness is thinner than about 1.0 nm, it is impossible to obtain a high-level reproduction signal because an MR ratio reduces.

The first free layer 43b′ and the second free layer 43d′ may be made of the same material and formed from the same layer structure, or made of different materials and formed from different layer structures to each other.

In a desired embodiment, the first free layer 43b′ may be formed from a (90CoFe)80B film with a thickness of about 0.5 nm and a 90CoFe film with a thickness of about 2.0 nm stacked on the (90CoFe)80B film. Also, the second free layer 43d′ may be formed from a 90(CoFe) film with a thickness of about 0.5 nm and a (90CoFe)80B film with a thickness of about 2.5 nm stacked on the 90(CoFe) film.

The nonmagnetic conductive layer 43c′ is made of for example Cu.

As will be noted from FIG. 6, the thickness of the nonmagnetic conductive layer 43c′ is selected within a range of about 0.6-4.0 nm. If the thickness is thicker than about 4.0 nm, it is difficult to induce an MR ration because this thickness of the free layer becomes in excess of a spin-diffusion length of the nonmagnetic intermediate layer material. If the thickness is thinner than about 0.6 nm, it is difficult to realize a high resistance state since ferromagnetic coupling state between the first free layer 43b′ and the second free layer 43d′ due to interlayer coupling becomes very strong.

On the second free layer 43d′, a cap layer 43e′ with a single-layered or two-layered structure made of a nonmagnetic conductive material such as for example Ru or Ta is stacked. In a desired embodiment, the cap layer 43e′ may be formed from an Ru layer with a thickness of about 1.0 nm and a Ta layer with a thickness of about 2.0 nm stacked on the Ru layer.

Functions and advantages of this embodiment are the same as those in the embodiment mentioned with reference to FIGS. 1 to 9.

Many widely different embodiments of the present invention may be constructed without departing from the spirit and scope of the present invention. It should be understood that the present invention is not limited to the specific embodiments described in the specification, except as defined in the appended claims.

1. A magnetic head device comprising:
a magnetic head section including a first free layer with a magnetization orientation that is not previously defined but changes depending upon only external magnetic field applied, a second free layer with a magnetization orientation that is not previously defined but changes depending upon only external magnetic field applied, a nonmagnetic intermediate layer sandwiched between said first free layer and said second free layer, a first electrode layer stacked on a surface of said first free layer opposite to said nonmagnetic intermediate layer, and a second electrode layer stacked on a surface of said second free layer opposite to said nonmagnetic intermediate layer;
a sense-current supply means for flowing a sense current across said first electrode layer and said second electrode layer of said magnetic head section; and
a frequency divider circuit for dividing by two a frequency of an output signal produced across said first electrode layer and said second electrode layer of said magnetic head section.

2. The magnetic head device as claimed in claim 1, wherein said magnetic head section further includes a buffer layer between said first free layer and said first electrode layer.

3. The magnetic head device as claimed in claim 1, wherein said magnetic head section further includes a cap layer between said second free layer and said second electrode layer.

4. The magnetic head device as claimed in claim 1, wherein said first electrode layer and said second electrode layer of said magnetic head section serve as a first shield layer and a second shield layer, respectively.

5. The magnetic head device as claimed in claim 1, wherein said nonmagnetic intermediate layer of said magnetic head section comprises a tunnel barrier layer.

6. The magnetic head device as claimed in claim 1, wherein said nonmagnetic intermediate layer of said magnetic head section comprises a nonmagnetic conductive layer.

7. The magnetic head device as claimed in claim 1, wherein said nonmagnetic intermediate layer of said magnetic head section has a thickness of 0.6 nm or more or 4.0 nm or less.

8. The magnetic head device as claimed in claim 1, wherein said nonmagnetic intermediate layer of said magnetic head section has a thickness of 2.5 nm or less.

9. The magnetic head device as claimed in claim 1, wherein said frequency divider circuit comprises a flip-flop circuit.

10. A magnetic disk drive apparatus having a magnetic disk, a magnetic head device with a magnetic head section, and a support means for supporting said magnetic head section so that said magnetic head section opposes to a surface of said magnetic disk, said magnetic head device comprising:
the magnetic head section including a first free layer with a magnetization orientation that is not previously defined but changes depending upon only external magnetic field applied, a second free layer with a magnetization orientation that is not previously defined but changes depending upon only external magnetic field applied, a nonmagnetic intermediate layer sandwiched between said first free layer and said second free layer, a first electrode layer stacked on a surface of said first free layer opposite to said nonmagnetic intermediate layer, and a second electrode layer stacked on a surface of said second free layer opposite to said nonmagnetic intermediate layer;
a sense-current supply means for flowing a sense current across said first electrode layer and said second electrode layer of said magnetic head section; and
a frequency divider circuit for dividing by two a frequency of an output signal produced across said first electrode layer and said second electrode layer of said magnetic head section.
